(19) United States
(12) Patent Application Publication
(10) Pub. No.: US 2012/0143881 A1
(43) Pub. Date: Jun. 7, 2012

(54) METHOD FOR POPULATION OF OBJECT PROPERTY ASSERTIONS

(75) Inventors: Christopher Baker, Grand Bay-Westfield (CA); ALEXANDER KOUZNETSOV, Waterloo (CA)

(73) Assignee: INNOVATIA INC., Saint John (CA)

(21) Appl. No.: 13/311,518

(22) Filed: Dec. 5, 2011

Related U.S. Application Data
(60) Provisional application No. 61/419,793, filed on Dec. 3, 2010.

(51) Int. Cl. G06F 17/30

(52) U.S. Cl. 707/750; 707/E17.099

(57) ABSTRACT

Relay of information from technical documentation by contact center workers to assist clients is limited by industry standard storage formats and query mechanisms. A method is disclosed for processing technical documents and tagging them against a Telecom Hardware domain ontology. The method comprises classical ontological Natural Language Processing (NLP) approaches to extract information from both text segments and tables, identifying text segments, named entities and relations between named entities described by an existing T-Box. A method for scoring candidate object property assertions derived from text before populating the Telecom Hardware ontology is also disclosed.

### CROSS-REFERENCE

This application claims the benefit of U.S. Provisional Application No. 61/419,793, filed Dec. 3, 2010, which application is incorporated herein by reference in its entirety.

### BACKGROUND

The contact centre industry has emerged as a major contributor to the economy of many industrialized nations, including Canada for which it contributes upwards of 4% of the nation's Gross Domestic Product (GDP). The industry norm is for Original Equipment Manufacturers (OEMs) to use a costly pay-per-seat outsourcing model for Contact Centre agents dedicated to servicing a group of customers. Despite the existence of Performance Tracker software for gathering metrics about call centres, there continues to be an omnipresent need for lower cost solutions and this drives Contact Centres to be more productive in the face of global competition. OEMs seek cheaper labour costs based on the same existing knowledge repositories and processes.

Within this industry there are several business challenges impacting customer satisfaction. Primarily there is a lengthy diagnosis phase involving call triage and routing. In the post triage phases, technical support teams spend 25 to 50% [1] of their time searching for case-specific answers in unlinked knowledge silos. In many cases poor knowledge discovery infrastructure results in case escalation to second tier agents as the time period for initial tier agents, 5 minutes or less, is frequently elapsed before solutions are found. OEM Knowledgebases have uneven quality across products and it is hard to find previous cases to provide guidance on how similar problems were resolved earlier. Experienced second tier agents familiar with technical publications for specific products are often in short supply and many cases languish unresolved. Moreover, within this business process there exist distinct phases and roles played by junior (Tier1) and senior agents (Tier2) requiring search tools of differing scope.

Knowledge discovery tasks carried out in the Contact Centre, are typically performed over a variety of repositories, both structured and unstructured, containing case notes on customer relationship management, and technical documentation. For instance, a single product may be documented across repositories in a variety of formats such as databases, PDF, HTML, FrameMaker, and XML.

In practice these resources are poorly integrated and only made accessible to Contact Centre agents through a variety of dedicated client interfaces. Typically, ad-hoc queries are made through multiple custom views and form-based query interfaces. Technical documentation for a product comprises of a Customer Relationship Management (CRM) database with up to tens of thousands of cases per year, technical bulletins, and technical publications (e.g. 38,000 pages of content, 4 active releases). Agents must link previous cases, symptoms, possible causes, suggested solutions and procedures from technical publications. The underlying strategy for data integration of technical documentation with CRM databases includes text mining for pertinent information and its integration with structured knowledge. To facilitate this in one or more embodiments of the invention, a technical solution is employed comprising Ontological Natural Language Processing involving named entity recognition, relation detection, ontology instantiation and knowledge-based interrogation with SPARQL and visual query.

### SUMMARY

In one or more aspects, the present invention relates to a computer-implemented method comprising providing a source corpus; providing a word list; identifying text in the corpus which is in the word list; tagging the identified text according to the word list; identifying a co-occurrence among the tagged text; determining the number of the co-occurrences in the corpus and the number of words between each of the co-occurrences in the corpus; and generating a score for the co-occurrence based on the number of the co-occurrences in the corpus and the number of words between each of the co-occurrences in the corpus.

In one or more aspects, the present invention relates to a computer-implemented method of populating an ontology comprising: providing a source text; annotating the source text; extracting literature specification units and a named entities from the annotated text; evaluating possible connections between two or more of the named entities based on co-occurrence of the two or more named entities in the literature specification units; identifying one or more of the named entities as A-Box individuals based on the evaluating step; providing an ontology; instantiating the ontology with the A-Box individuals and object properties between the individuals according to scores above a predetermined threshold.

The invention, in one or more aspects, relates to accurate extraction and population of relations between the named entities and population as object properties between A-box individuals in an OWL-DL ontology. See, for example, FIGS. 1 and 2.

In another aspect, Ontology-based information retrieval applies Natural Language Processing (NLP) to link text segments, named entities, and relations between named entities to existing ontologies.

In another aspect, the invention relates to an algorithm which: leverages a customized gazetteer list, including lists specific to object property synonyms; scores A-box property candidates by using functions of distance between co-occurred terms; and performs A-box Property prediction and population based on these scores (Thresholds, Fuzzy approach)

In another aspect, the invention relates to the generation of scores leveraging a relation collection framework to process relation objects; relation objects are identified as Domain Class: Domain Instance; Object Property: Range Class: Range Instance. The co-occurrences of relation object data are integrated to facilitate scoring of candidate object property assertions: all types of related text fragments, ontology objects and score processing intermediate and final results.

In another aspect, the invention relates to a score generator comprising: a score calculator which carries out score calculation for text fragments associated with relation objects. In one or more embodiments, the score calculation is based on distance between occurred entities and the number of text fragments with co-occurrence. In one or more further embodiments, a text fragment processor and integrator are used to generate text fragments.

In another aspect, the invention relates to score generation for multiple formats suitable for technical documentation containing knowledge displayed in multiple formats, each requiring different processing subroutines namely: table processing, sentence processing, and other segments.

In another aspect, the invention relates to a sentence scoring process comprising: generating an A-box object property score for one or more sentences according to the formula: Sentence Score=1/(distance+1)+Bonus; integrating the object property scores over all related sentences according to the formula: Integrated Score=SUM(SentenceScore); and normalizing the object property score according to the formula: Normalized Score=IntegratedScore/Norm. In a further embodiment, the method further comprising providing a table score for text in a table and summing the integrated object property score with the table score.

In another aspect, the invention relates to use of thresholds decision boundaries to determine the relevance of scores generated for sentences and tables where: all scores for each A-box property candidate are summarized based on eligible sources of evidence for the A-box in question; thresholds are derived and optimized for ontology population; and thresholds are used to facilitate end user options favoring either recall or precision.

The invention, in one or more further aspects, relates to a method for scoring and populating a telecommunications (“Telecom”) knowledgebase that provides users a degree control over the fidelity of the search results but allowing users to opt for different levels of precision and recall. In determining the degree of confidence they wish to have in the accuracy of the knowledgebase, different users can conduct custom searches to meet their needs.

The invention, in one or more further aspects, relates to methods applicable to the Telecom domain. In one or more embodiments, methods of the invention can also be used to solve the problem of populating the correct relations between individuals comprising scoring candidate A-Box object properties depending on textual occurrences of relations and how close they are to the textual descriptions of their respective domain and range in the T-Box.

In one or more embodiments, methods of the invention relate to a semi-automatic approach for knowledge discovery which is based on manual creation and curation of a T-Box ontology together along with synonym lists of entities and relations. The T-Box can then be reused in a text mining module for A-Box individual and relation discovery.

### DESCRIPTION OF THE DRAWINGS

FIG. 1 depicts an example of an A-Box/T-box ontology;

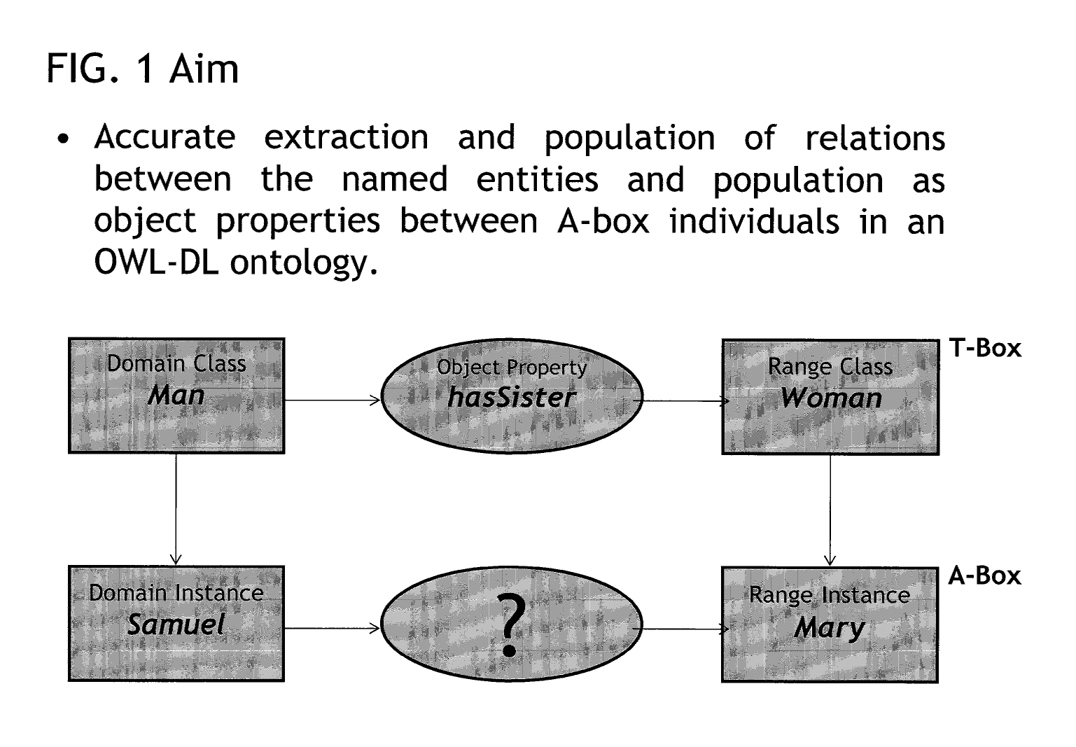

FIG. 2 depicts an example of the population of an A-box Object Property in the ontology of FIG. 1;

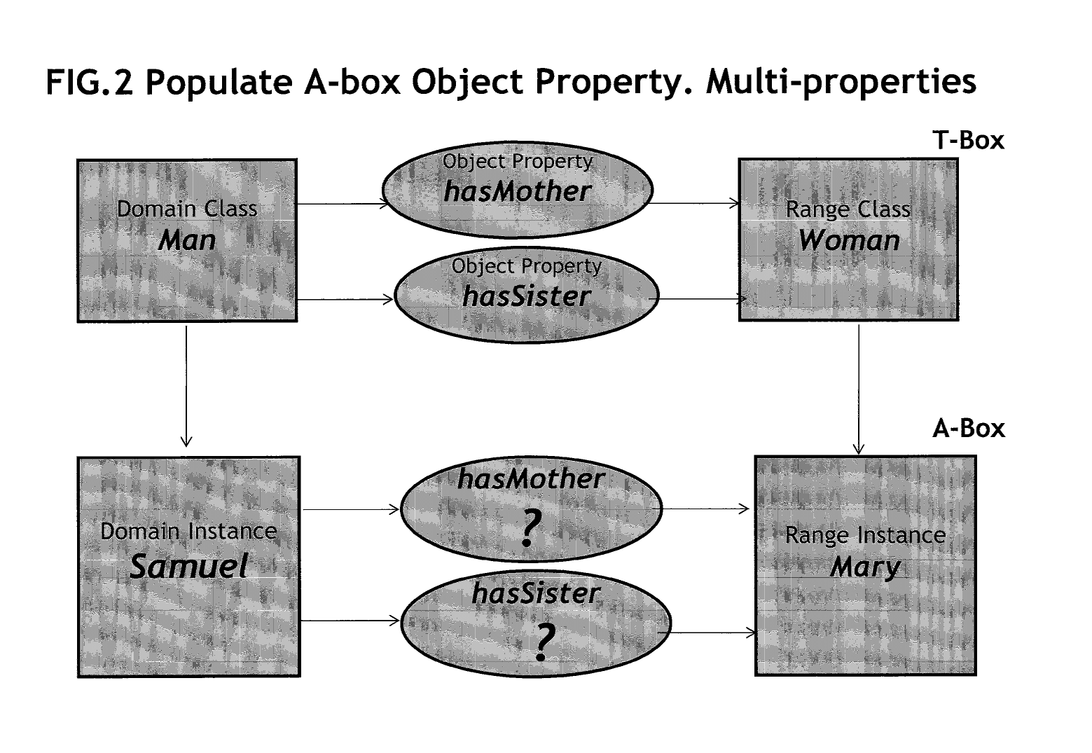

FIG. 3 is an overview of semi-automatic ontology population according to an embodiment of the invention. The System Inputs are; Gazetteer (term list), unpopulated ontology, source text. The first layer of preprocessing involves clean up of input and conversion into GATE compatible format, followed by initiation of the text processing pipeline and connection with external resources. The second layer involves running the pipeline to annotate source text with Gazetteer list named entities and literature specification units. The third layer involves the extraction of named entities from annotated text and population of individuals into the ontology, followed by evaluation of possible relations between them, based on scoring and then populating object properties. Some data properties (such content of text segments) are also populated. The output is a populated ontology for end use queries. System Inputs are; Gazetteer (term list), unpopulated ontology, source text. The first layer of preprocessing involves clean up of input and conversion into GATE compatible format, followed by initiation of the text processing pipeline and connection with external resources. The second layer involves running the pipeline to annotate source text with Gazetteer list named entities and literature specification units. The third layer involves the extraction of named entities from annotated text and population of individuals into the ontology, followed by evaluation of possible relations between them, based on scoring and then populating object properties. Some data properties (such content of text segments) are also populated. The output is a populated ontology for end use queries.

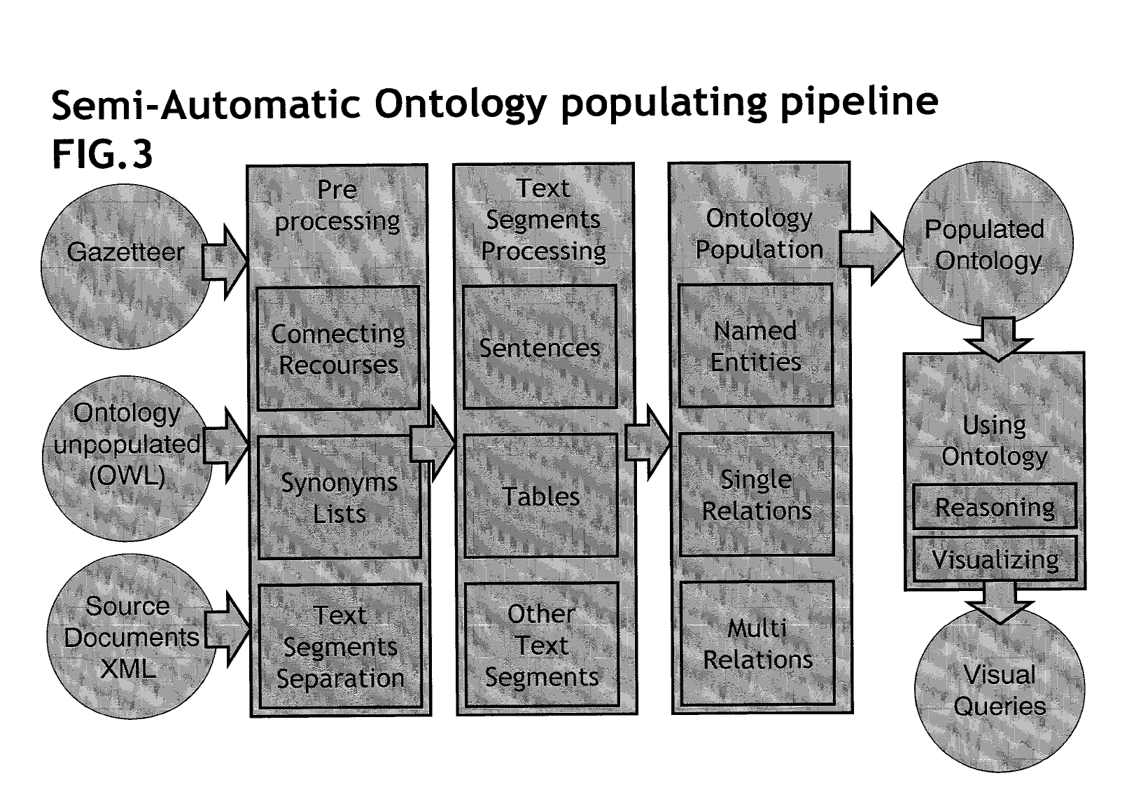

FIG. 4 is a generalized flow diagram of an ontology population method according to an embodiment of the invention; it involves a scoring framework for A-box object property candidates (triples) comprising of domain individual: obj prop: range individual, where individuals should occur in source text and the parent classes should be connected by this relation in T-box. Each candidate is evaluated with respect to all evidence occurring in source text. All co-occurrences of synonyms for domain, range and property are taken into account and evaluated and each candidate is the assigned with a score. In the Decision framework decisions are made to populate candidate triples based on a pre determined threshold. Threshold boundaries are derived by a supervised learning from a manually annotated corpus with optimal precision and recall. The framework includes extensions to record both binary and fuzzy scores.

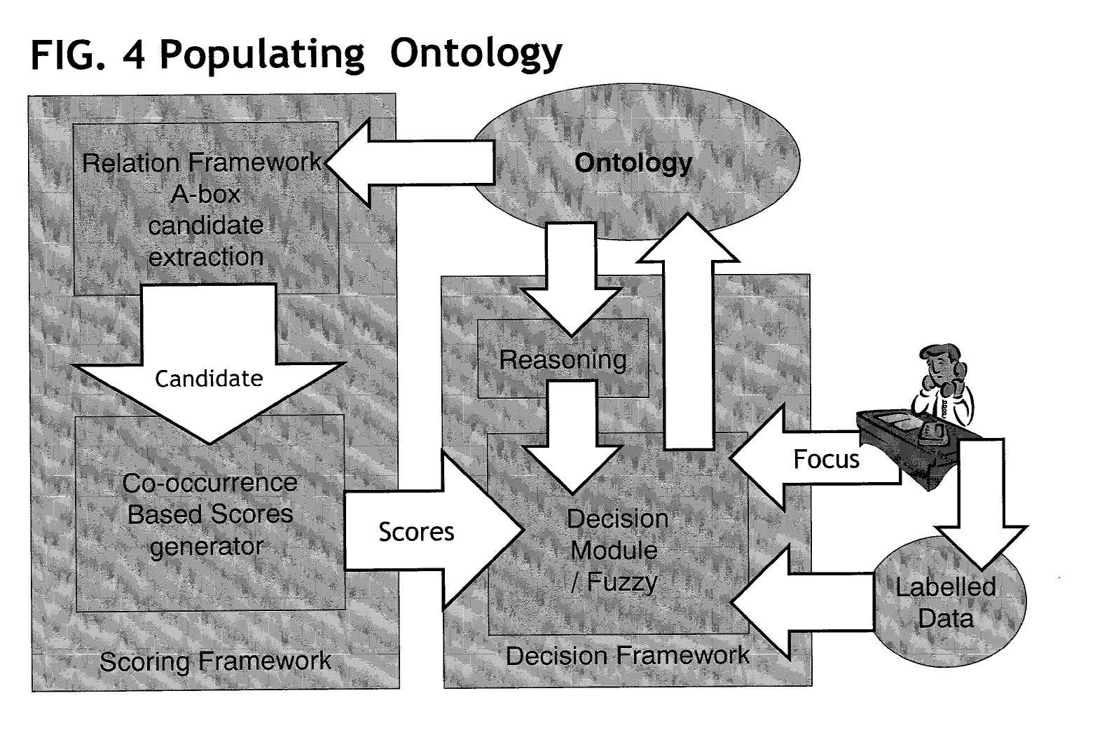

FIG. 5 is a depiction of a co-occurrence based score generator according to an embodiment of the invention; The Relations framework is a Java object to encapsulate collections of relation objects and methods to process them through candidates extraction, scoring and final evaluation. The relation object is a Java object to wrap object property candidates, all evidence extracted from source text and any A-box and T-box related information that is relevant to the evaluation of a given candidate. The Fragment Processor scores each segment that is extracted as a piece of evidence for the current candidate. The Integrator summarizes all fragment scores for the current candidate and normalizes this integrated score to the final score for the candidate.

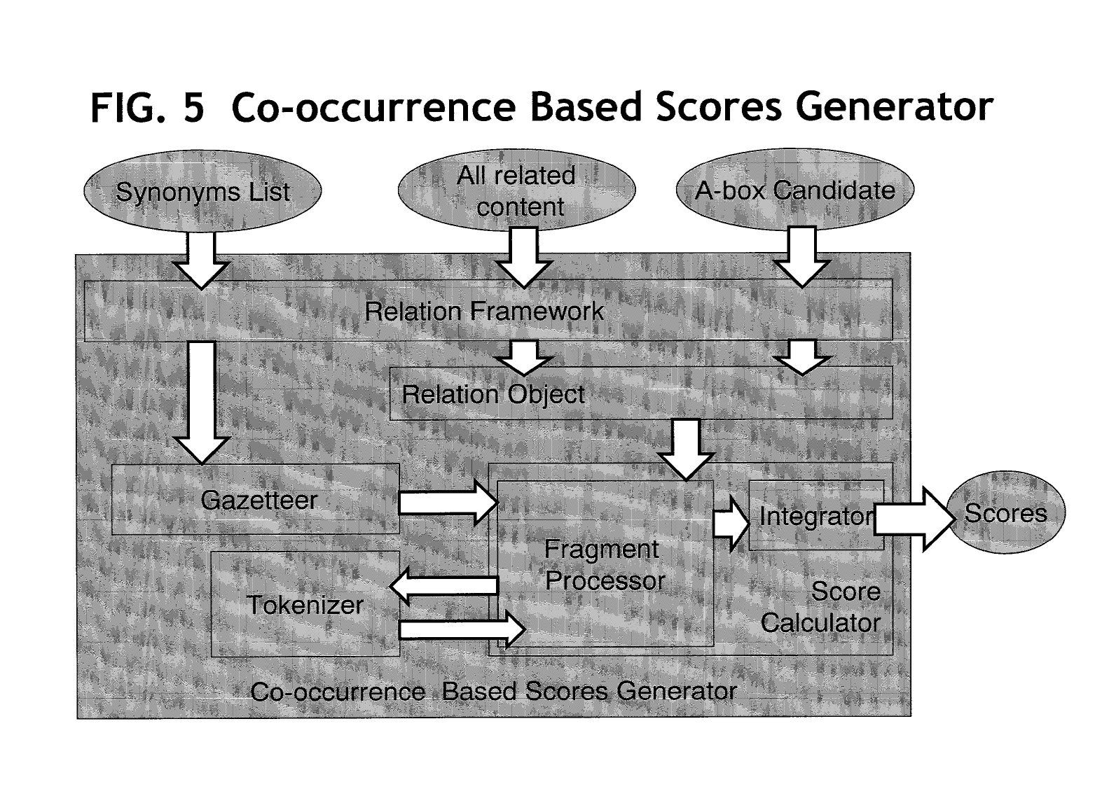

FIG. 6 is a depiction of an extensible data model according to an embodiment of the invention; the mode incorporates sentence and tables fragments, including 4 sub fragments, and variable extensions; additional literature specification units, text Sections, paragraphs, bullet lists, headings are available.

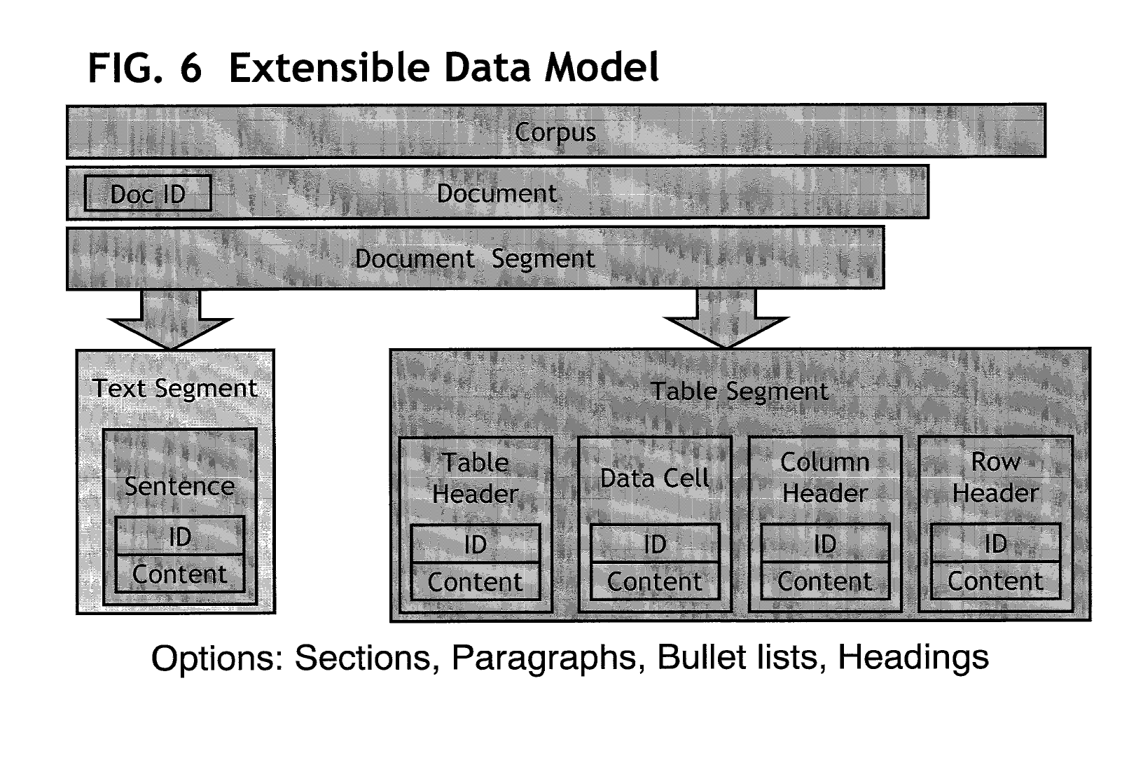

FIG. 7 is a depiction of A-Box property candidates according to an embodiment of the invention; whereby candidates are generated based on valid T-box triples in the Ontology and the determination of sufficient term co-occurrence identified using text mining resources. Scored candidate object properties with co-occurences are normalized relative to single term occurrences prior to ontology population.

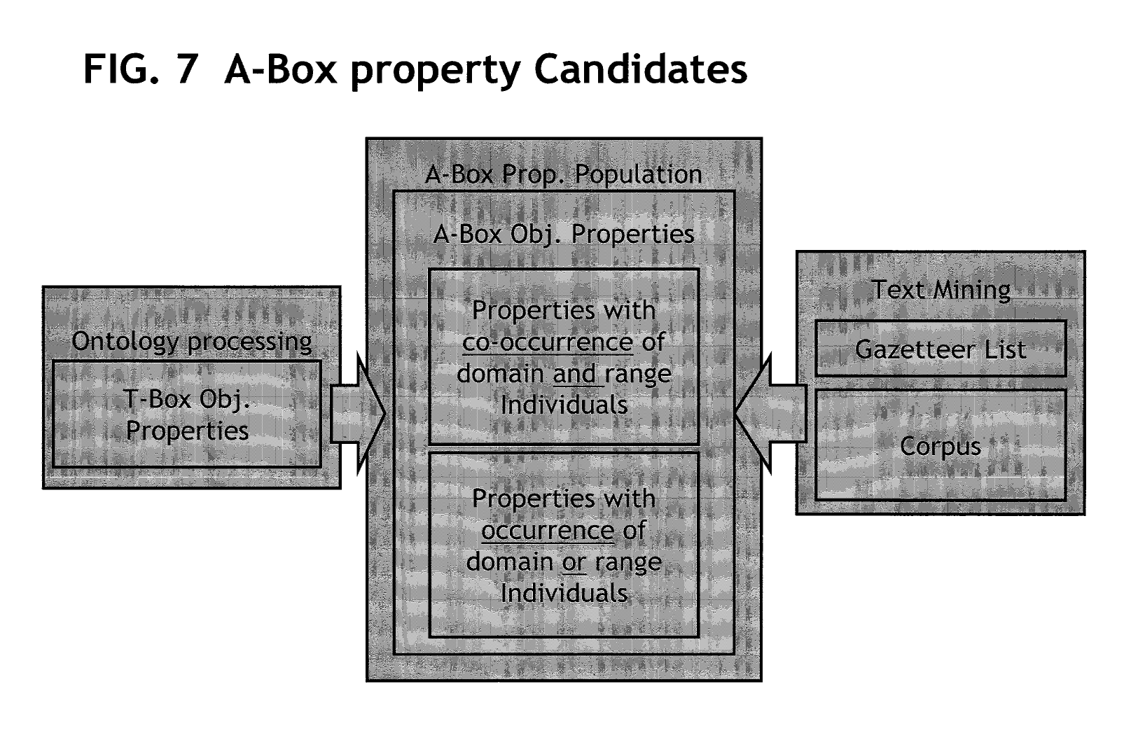

FIG. 8 is a depiction of evidences for A-box object property candidates according to an embodiment of the invention; specifically two types of evidence are gathered, firstly evidence of occurrence of terms (only domain or only range) which are used for normalization of integrated sentence and table scores, and secondly evidence of co-occurrence (domain and range both) which is the main evidences for segment scoring.

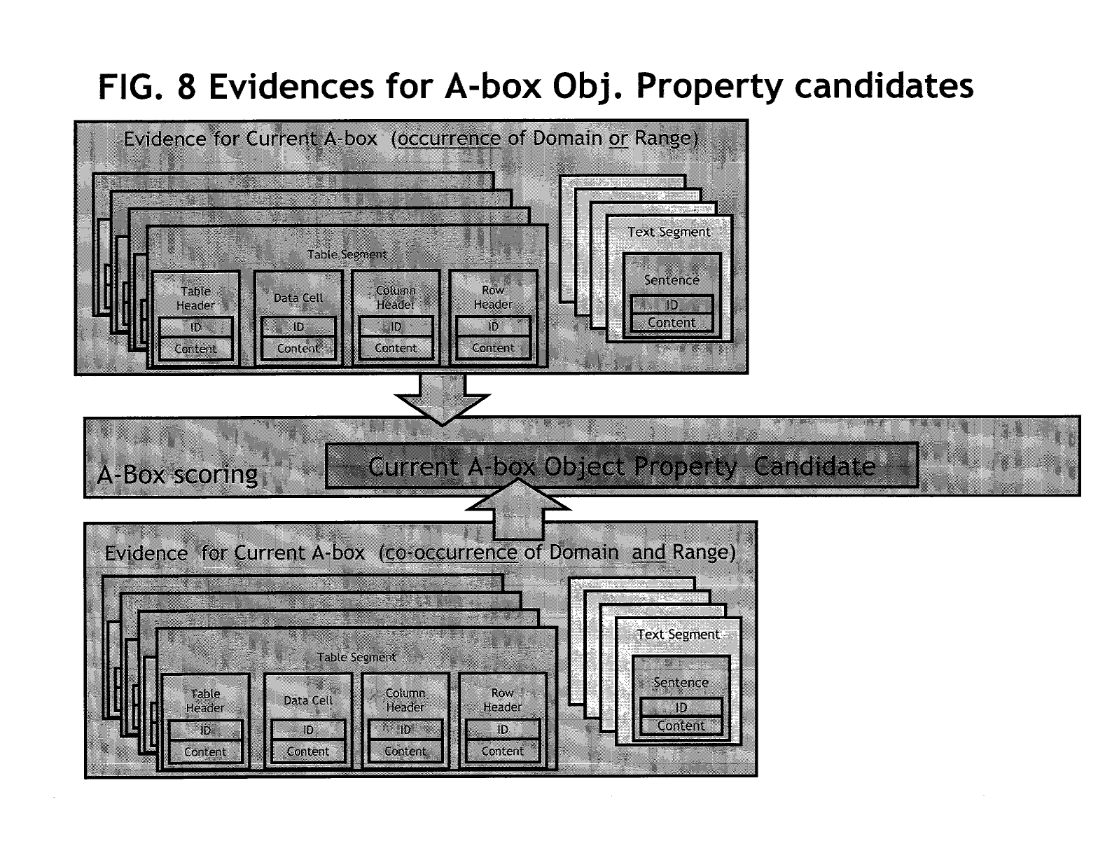

FIG. 9 is a table entitled “Table Segments: Primary Scoring” according to an embodiment of the invention; high scores are assigned to table segments where an object property or synonyms occur in data cells and the corresponding domain and range synonyms occur in other sub segments of this table segment.

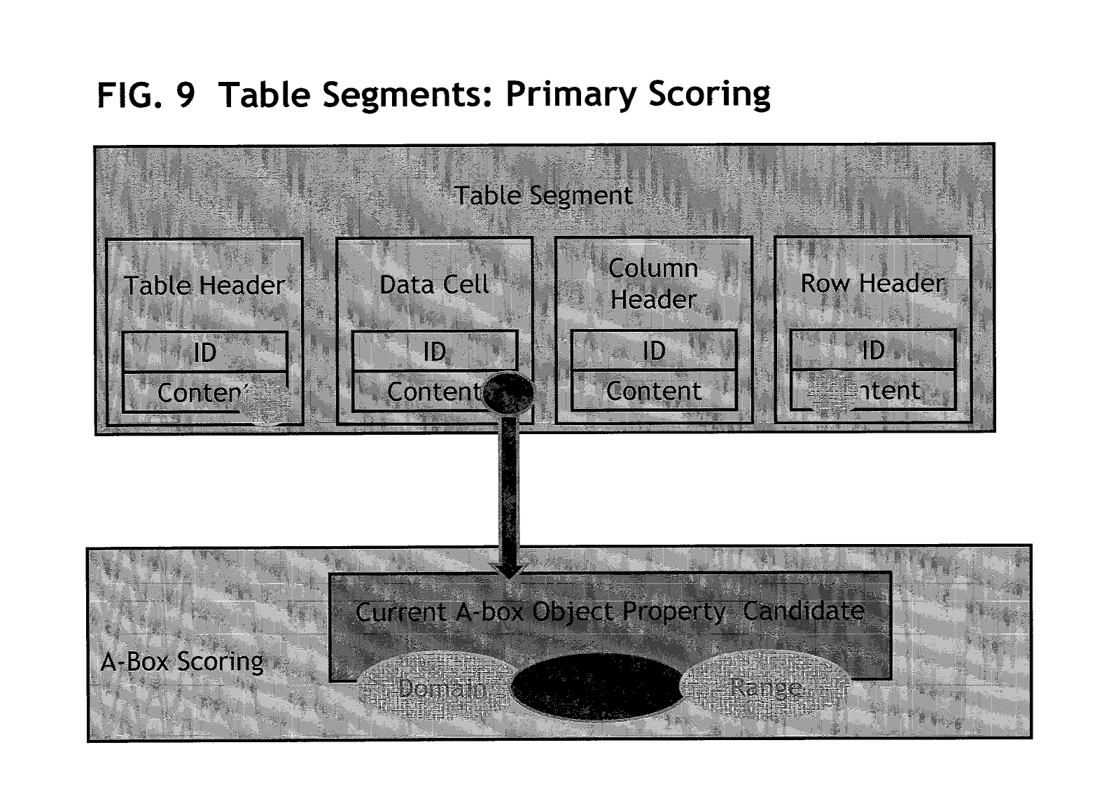

FIG. 10 is a table entitled “Table Segments: Secondary Scoring” according to an embodiment of the invention; secondary scores are applied in cases where object properties occur in any sub segment other than the Data Cell. Scores are also given for occurrences of domain and range terms in other segments albeit lower than for primary scoring.

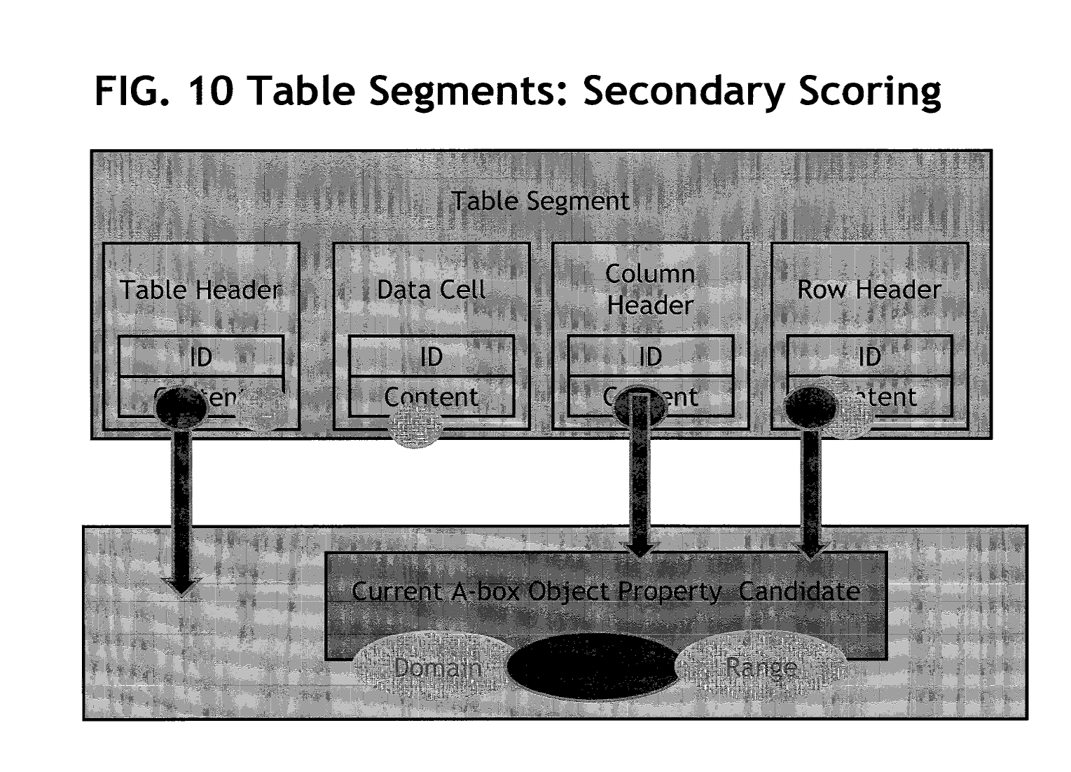

FIG. 11 is a depiction of sentence scoring according to an embodiment of the invention; Described here are four types of term co-occurrence, in the first case the co-occurrence happens outside of the sentence content, in surrounding XML tags, and an artificial distance penalty is applied resulting in a very low score. The second case shows only a domain and range co-occurrence, with no property synonym, and no bonus score for a complete triple. The third case shows a 3 term co-occurrence, albeit the object property is not located between the domain and range terms. A small bonus score is given. The fourth case shows a 3 term co-occurrence with the object property located between domain and range terms and the highest bonus score is assigned

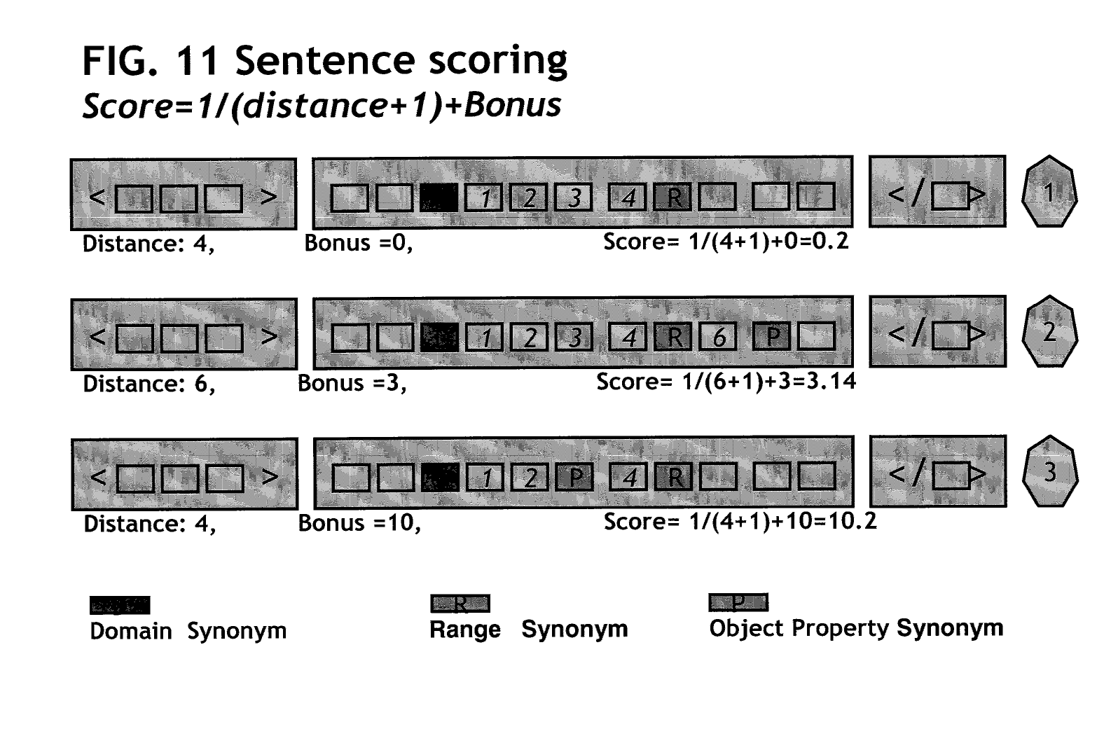

FIG. 12 is a depiction of an example sentence type 1 according to an embodiment of the invention;

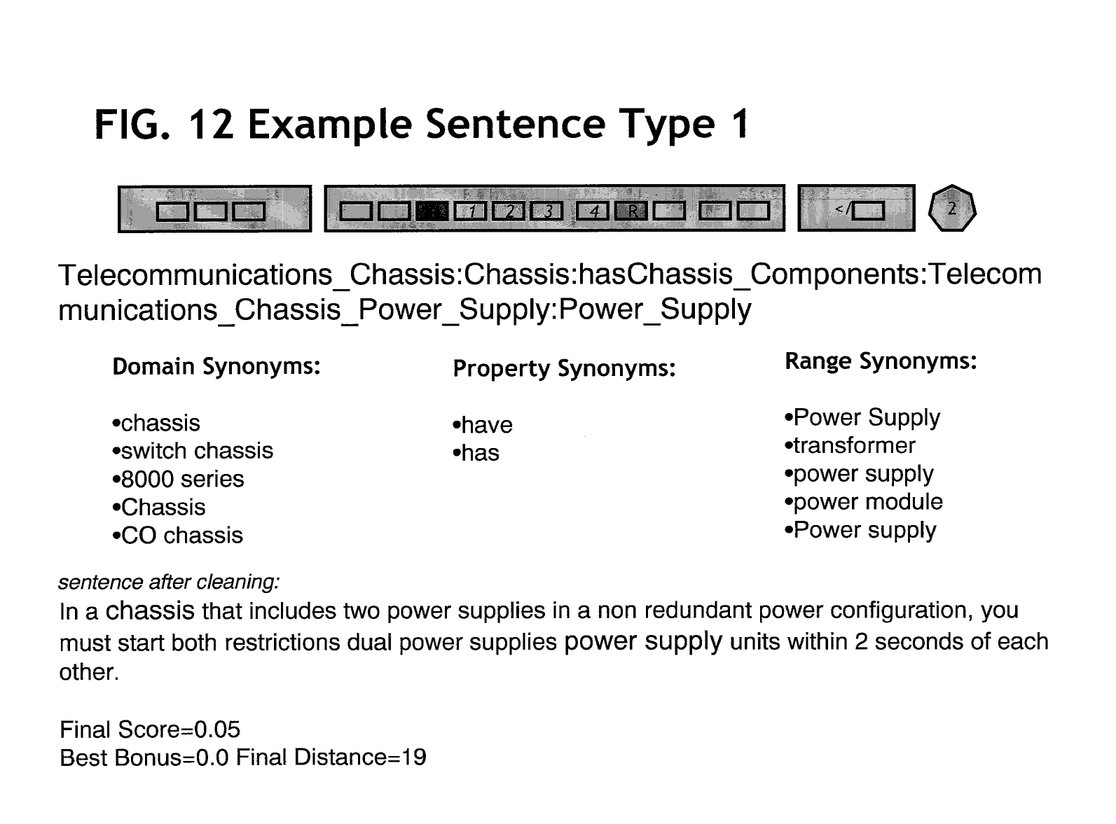

FIG. 13 is a depiction of an example sentence type 3 according to an embodiment of the invention;

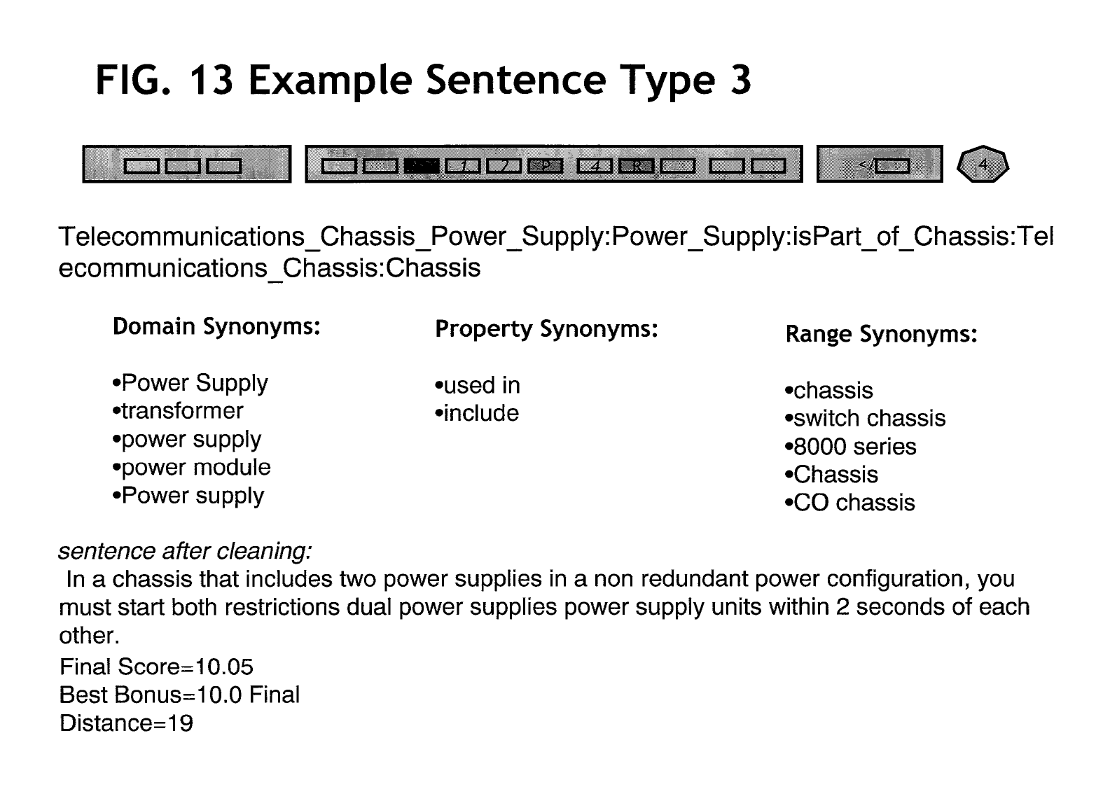

FIG. 14 is a depiction of a bonus calculation according to an embodiment of the invention; the example shows that object properties comprising of multiple term words are scored higher than only single word object property terms.

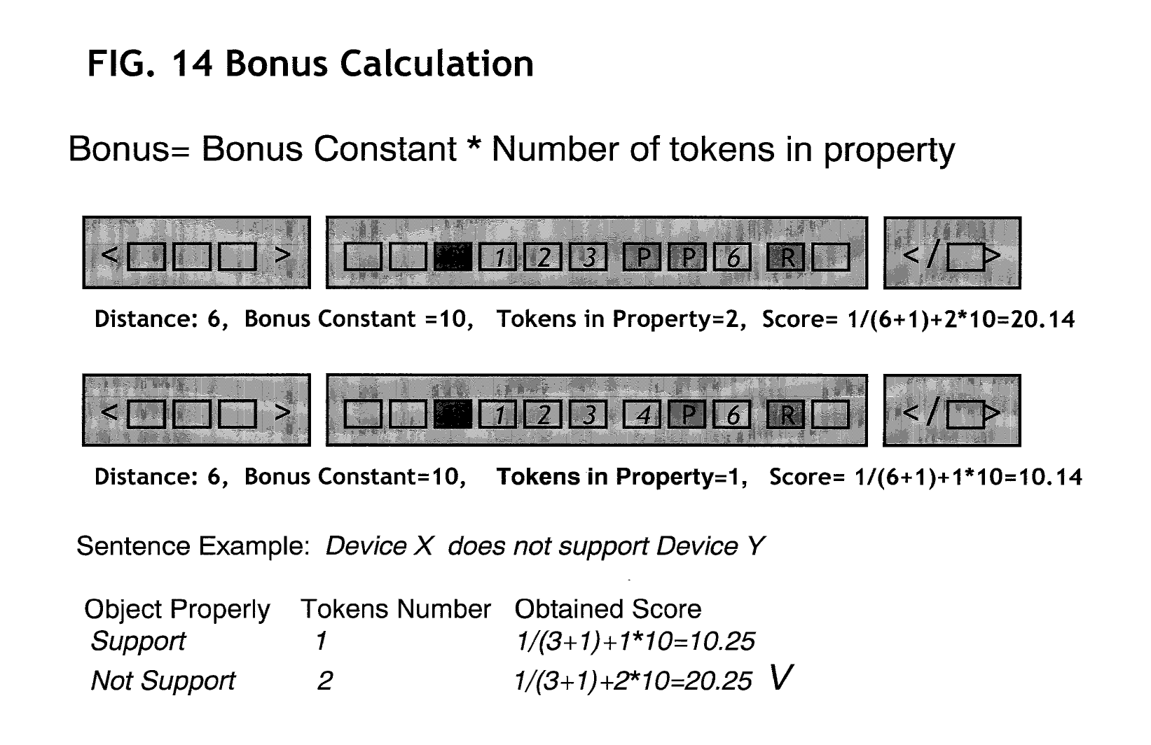

FIG. 15 is a depiction of normalization according to an embodiment of the invention;

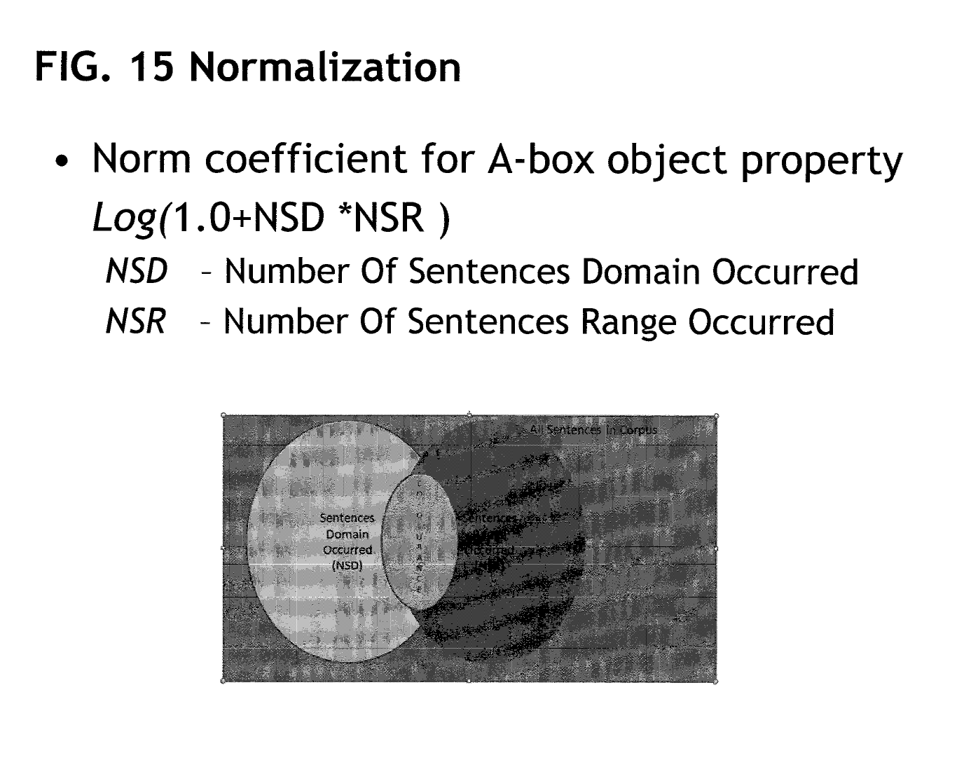

FIG. 16 is a depiction of an evaluation framework according to an embodiment of the invention; The framework comprises of an evaluation/prediction framework including a gold standard database with labeled candidates, a portion of which are used for supervised learning of thresholds and bonuses.

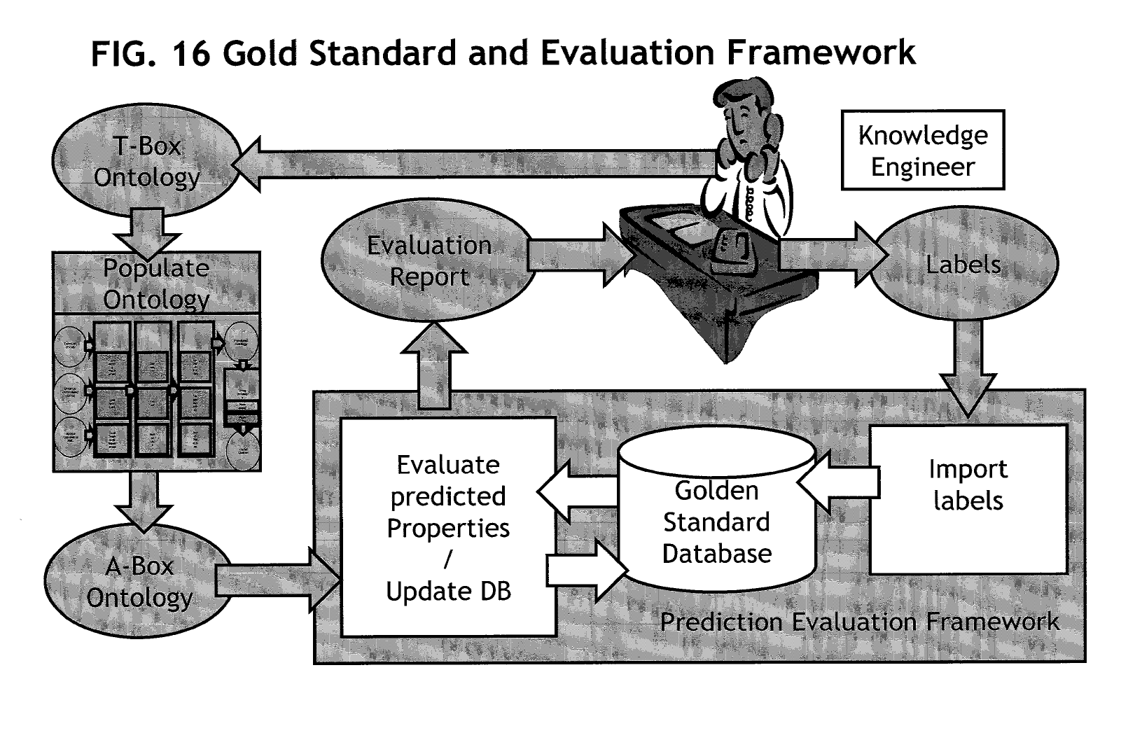

FIG. 17 depicts a general architecture according to an embodiment of the invention comprising of XML documents with paragraph and tables mark-ups generated using GATE, (1) and further comprising of a Telecom ontology and gazetteer lists (domain-, range- and property synonyms) (2); the ANNIE tokenizer and sentence splitter (3); a relation extraction module linking relations to previously identified entities (4) a Scoring Module (5); a module populating valid candidates into the ontology and being connected to annotated documents (6).

FIG. 18 is a depiction of a method for extracting entities from Telecom documentation according to an embodiment of the invention; the graphical browser product Top Braid Ensemble is used to construct a graphical query to the populated knowledgebase.

### DETAILED DESCRIPTION

Ontology Design In one embodiment, the advantages of the OWL 2 framework are combined with its expressive Description Logics (DL) without losing computational completeness and decidability of reasoning systems. TopBraid Composer Maestro Edition is used as a knowledge representation editor because of its industrial robustness and visual paradigm querying capabilities. The Telecom Ontology developed has a high level of granularity. The Knowledge acquisition and data integration phase of ontology development leveraged telecommunications call routing product information from product technical publications over several software releases and data from a technical support case resolution database. The role of the ontology is provide Technical Support Contact Center Engineers with a problem solving ontology that represents core hardware concepts, product failure symptoms to known problems and procedures to resolve errors. The specific domain under consideration is the networking of telecommunications hardware. The scenario comprises network routing servers, including the compatibilities of telecommunications switch a Technical Support Agent that needs to consult a knowledgebase when liaising with a client asking questions about hardware compatibility, installation or troubleshooting. For such queries the following object properties are created:

(1) Compatibility linkages between various components:

Chaśsis→\check{h}asAC\check{_}Power_Supply→AC_Pówer_Supply.

(2) Linkages between components and the various kinds of procedures for the components:

Chassis→hasProcedure→Procedure.

The ontology was designed to be reusable across many products. A top level literature specification was introduced to represent text segments found in technical documentation from different OEMs. The ontology statistics are shown in Table 1.

TABLE 1
Ontology Statistics

| | | | | | |
|---|---|---|---|---|---|
| Classes: | 506 | Instances: | 8800+ | Data Properties: | 47 |
| Object | 167 | Subclass | 505 | Class | 37 |
| Properties: | | Axioms: | | Equivalencies: | |
| Sub Object | 48 | Object Property | 388 | Object Property | 252 |
| property: | | Domain: | | Range: | |

Ontology Population

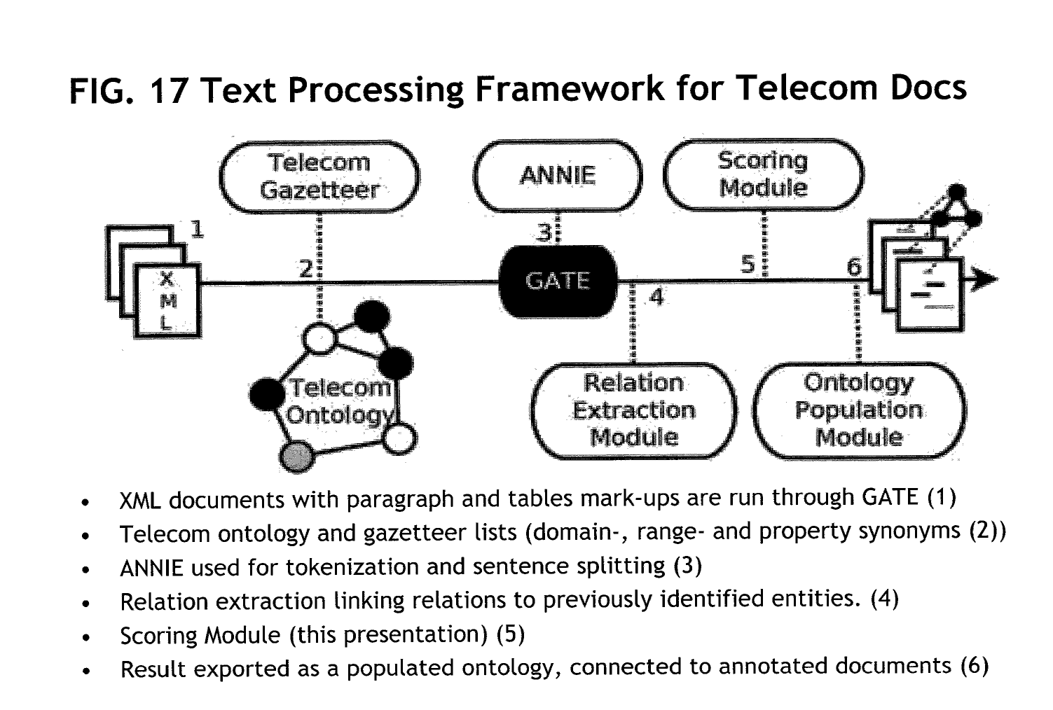

Ontology Population is the process of adding instances, derived from text mining, to a premodelled ontology. In one embodiment of the present invention, the general architecture applied is presented in FIG. 17. The inputs include: (i) unpopulated Telecom OWL-DL ontology (T-box Ontology), (ii) Telecom Gazetteer and (iii) Telecom Contact Center technical support documentation. The first layer of the pipeline software, namely a Preprocessing Layer, provides functionality to clean up and convert input into the pipeline compatible format; secondly, it connects resources and runs the text processing pipeline to annotate source text with the help of gazetteer lists with Telecom Ontology concept synonyms. The second layer, Text Segment Processing includes extracting literature specification units and named entities from annotated text, and evaluating possible connections between named entities based on co-occurrence of named entities synonyms in the text segments. The third layer, Ontology Population, makes it possible to instantiate the Telecom Ontology with A-box individuals, their data properties and object properties established between them.

Text Processing

As a basis for text processing, GATE, an open source framework is used with a variety of components for information extraction, semantic annotation etc [2]. GATE comes with many plug-ins and processing resources by default, where one of them is the ANNIE component. ANNIE can be used for common NLP tasks such as tokenization, sentence splitting, part of speech tagging and creation of gazetteer lists. To further use annotated entities, JAPE (http://gate.ac.uk/) is used and provides “finite state transduction over annotations based on regular expressions.”, which is useful for finding complex entities and relations between found entities. JAPE also makes it possible to incorporate custom-made components written in Java to the GATE pipeline, for example the Owl API [3], which is used as a complement to the Ontology tools provided by GATE per default. FIG. 17 shows an overview of a GATE pipeline according to one or more embodiments of the invention.

Relation Extraction

Relation Extraction is a method that is performed using each triple statement, comprising of a domain, object property and range, in an ontology T-box according to the invention. This method includes:

(1) Identification of all Domain and Range classes, and associated subclasses, of object properties defined at the T-box level of the ontology;

(2) Identification of all individuals for each class detected as a domain or range class on the previous step; and

(3) Projecting the T-box property to the individuals identified in step (2) by forming candidate object property assertions (Candidate OPA or A-box candidate object properties) based on the evidence provided by the scoring algorithm.

Telecom Literature Specification and Text Segmentation

The literature specification or the bibliographic sub-ontology is a major part of the Telecom Ontology, comprising 135 concepts in the current version.

The following literature specification concepts are used in text mining methods according to one or more embodiments of the invention: Sentence, Table, Table Header and Table Cell. All of these concepts are subclasses of the Text Segment concept. Text Segment also includes other sub concepts such as Paragraph, Bullet List and Topic. Text segments are also connected to each other through the isPartOf object property.

As previously mentioned, ANNIE is used for sentence splitting, and the sentence content is considered as a piece of text surrounded by two sentence splitting delimiters. The pipeline extracts each sentence from the source corpus and creates sentences individually in the ontology (each sentence is represented as a distinct individual of the Sentence class). Telecom entities found in the text are instantiated in the ontology and connected to the instances of the text segments in which they occur, through e.g. the occursInSentence object property. Since named entities occur not only in raw text, processing table data was also looked at. Tables and table cells are extracted based on already existent mark-up in the Telecom source XML documents. According to the literature specification, the Table Cell concept includes three subclasses: Data Cell, Column Header Cell and Row Header Cell.

The pipeline creates individuals for each table from the text. If the table has a header, the table header individual is created and connected with table individuals using the object property hasHeader and the table header's data property is populated with table heading content. Also, the pipeline processes each XML table cell tag and recognizes to what subclass the current table cell belongs. After that, the pipeline creates an individual of related subclass. The pipeline connects each data cell with the relevant column header cell and row header cell by populating the object properties hasColumnHeader and hasRow-Header respectively. Connections are also made between each cell and the table it belongs to.

Data cell, Column Header Cell and Row Header Cell are subclasses of the Cell Class. While Cell Class and Table Header are subclasses of Text Segment class. Sentence is a sibling to Cell. Any named entities occurring in the content of individuals of Text Segment subclasses are processed in the same way as described above for the processing of named entities in Sentence content (the individuals of relevant Telecom classes are created and connected with literature specification individuals where the named entity occurred).

Text Segments Scoring Algorithms

In one or more embodiments, the text segments employed for scoring, sentence and table segment, have a different structure. Whereas sentences include only one piece of content (sentence content itself), the table segment includes four pieces of information (data cell content itself and content of related headers). To address the diversity in the applied text segment structure, two different scoring algorithms have been proposed: the first one focuses on sentence processing and the second one allows scoring of the table segments. Despite the difference in the implementation details, both scoring methods used a general approach that employs the following steps:

(1) Content is analyzed with respect to candidate OPA triple that includes domain individual, object property, and range individual;

(2) Content analysis is based on recognizing the occurrence of three types of named entities: domain individuals and synonyms of domain individuals; object properties and synonyms of object properties; and range individuals and synonyms of range individuals;

(3) The occurrence of each type of named entity in the content increases the score (ideally all three types should co-occur); and (4) Analyze the relative location of each named entity co-occurrence.

Sentence Scoring Algorithms

Sentence Score S^{s}ᵢⱼ for sentence j is extracted as evidence for a candidate OPAᵢ is calculated as:

$${S}_{ij}^{s} = \frac{1}{( d + 1 )} + B$$

where d is the distance between co-occurred named entities and B is a bonus. The way to calculate distance and bonus depends on the type of named entities co-occurrences that were found in the sentence j content. Only named entities involved in the candidate OPAᵢ are taken in account. There are 3 types of co-occurrence of domain individual synonym, range individual synonym and object property synonym to be considered; these are described below:

(1) At least one domain individual or synonym and at least one range individual or synonym co-occurred in the sentence. There is no object property synonym occurrence in the sentence. Allowable configurations are [Domain Range] or [Range Domain]

(2) At least one domain individual or synonym, at least one range individual or synonym and at least one object property or synonym co-occurred in the sentence. The sentence does not include any object property term or synonym that is located between the domain or synonym and the range of synonym or located between the range or synonym and the domain or synonym (range or synonym and domain or synonym should be located in the same sentence). The only allowable configurations are [Object Property Domain Range] or [Domain Range Object Property] or [Object Property Range Domain] or [Range Domain Object Property]

(3) At least one domain individual or synonym, at least one range individual or synonym and at least one object property term or synonym co-occurred in the sentence. The sentence can include any object property term or synonym located between the domain or synonym and the range or synonym, and can include the converse where the sentence includes or any object property term or synonym located between the range or synonym and the domain or synonym (range or synonym and domain or synonym should be located in the same sentence). Allowable configurations are [Domain Object Property Range] or [Range Object Property Domain]

The Type 1 co-occurrence bonus B₁ is equal to zero. The Type 1 distance is the number of tokens that occur between the domain or synonym and the range or synonym.

The Type 2 co-occurrence where bonus B₂ is a positive value (B2>B1). The Type 2 distance is max(d₂^{PD}; d₂^{PR}), where d₂^{PD} is a number of tokens that occur between the domain or synonym and the object property or synonym, d₂^{PR} is a number of tokens that occur between the range or synonym and the object property or synonym.

The Type 3 co-occurrence bonus B₃ is a positive value greater than B₂ (B₃ >B₂). The Type 3 distance is a number of tokens that occur between the domain or synonym and the range or synonym.

In the case where the same sentence can have different types of co-occurrence and/or more than one occurrence of domain, range or object property or synonyms, the maximum overall score possible scoring for this section should be selected as the final score for this sentence.

Table Segment Scoring Algorithm

The table segment scoring algorithm comprises two steps:

(1) Join all data cell-related content to one piece of text and process it on the same way as it is described above for the sentence; and,

(2) Add table bonus scores according to the location of the object property synonym with respect to the table segment structure.

Joined contents are separated by a space delimiter. Concatenated content is processed and scored as a sentence according to above described sentence scoring algorithm. The score S^{t}ᵢₖ is the output of the table segment scoring algorithm's first step for table segment k with respect to candidate OPA_{i.} On the second step, the following rules were applied:

(1) In the case of at least one object property or synonym occurring in the content of data cell itself, the table segment score S^{t}ᵢₖ increased with non-negative value T1.

Sᵢₖ^{t}=Sᵢₖ^{t}+T₁, T₁>1

(2) In the case of at least one object property or synonym occurring in the content of row header cell, column header cell or table header, the table segment score S^{t}ᵢₖ increased with non-negative value T₂.

Sᵢₖ^{t}=Sᵢₖ^{t}+T₂, T₂>T₁

Score Integration and Normalization

The integration score Sᵢ^{I} for candidate OPA_{i.} is calculated as:

$${S}_{i}^{I} = {\sum }_{j} {S}_{ij}^{ s} + {\sum }_{k} {S}_{ik}^{ t}$$

The normalized score Sᵢ^{N} is evaluated according to following equation:

$${S}_{i}^{ N} = \frac{{S}_{i}^{ I}}{log ( 1 + {N}_{d}^{ i} + {N}_{r}^{ i} )}$$

where Nⁱ_{d} is the number of text segments in the corpus where at least one domain individual synonym occurred and Nⁱᵣ is the number of text segments in the corpus where at least one range individual synonym occurred.

Domain and range individuals are considered with respect to candidate OPAᵢ. The applied normalization approach is focused on decreasing scores of evidence based on occurrence of terms common for the whole corpus, i.e. the objective is prioritizing evidences obtained with terms that are specific to this candidate OPA related segments rather than for the whole corpus. Finally, Sᵢ^{N} scores are normalized to interval [0;1]. The final output of the scoring algorithm is a set of scores Sᵢ ^{N[0,1]}

0≦Sᵢ^{N[0,1]}≦1

Using Scores for Ontology Population

The scores produced by our algorithms are ultimately to be used for ontology population of object property assertions. There are at least two possible ways to use these scores: a binary and a fuzzy approach.

The binary approach, used in one or more embodiments of the invention, is based on converting candidate OPA score Sᵢ^{N[0,1]}, that is a real number between 0 and 1, to binary value Sᵢ^{B{0,1}}.

Sᵢ^{N[0,1]}→Sᵢ^{B{0,1}}, Sᵢ^{B{0,1}}ε {0, 1}

While Sᵢ^{B{0,1}}=0 means that the candidate OPA should be not be populated (this A-box triple is not added to ontology), Sᵢ^{B{0,1}}=1 means an A-box triple should be added in the ontology (property populated).

The fuzzy approach is based on using norm-parameterized fuzzy description logic [4] that extends classical description logics to many-valued logics. In this paradigm Sᵢ^{N[0,1]} scores and candidate OPA could be considered as a representation of uncertain knowledge. The syntax and semantic of norm-parameterized fuzzy description logic allows integrating candidate OPA and related scores in norm-parameterized fuzzy description logic ontology.

In one or more exemplary embodiments, a binary approach is used (a fuzzy approach can also be used). Scores Sᵢ^{N[0,1}] are converted into binary values Sᵢ^{B{0,1}} by using thresholds 0<Ti<1. The converting rules are presented as:

Sᵢ^{N[0,1]}<Tᵢ [symbol] Sᵢ^{B{0,1}}=0

Sᵢ^{N[0,1]}≧Tᵢ [symbol] Sᵢ^{B{0,1}}=1

The thresholds Tᵢ are learned from human expert labeled candidate OPA. A supervised learning approach is applied that has some similarity to the threshold learning approach presented in previous work [5].

Experiment Settings and Results

Experiment Data

269 candidate OPA were extracted. Candidates were reviewed by a human expert and labeled with respect to two classes: positive class that includes candidate OPA to be populated, and negative class that consist of Candidate OPA not to be populated. In other words, positive class includes relations that are identified by the expert as really existing relations while negative class include candidates that establish relation between individuals that are really not connected in terms of the involved object property. The positive class includes 211 candidate OPA while negative class includes 58 candidate OPA. The extracted set was randomly split (after stratification) to training set (30%) and test set (70%). The training set was used to learn thresholds and bonuses values.

Experiment Settings

A set of experiments were run to predict candidate OPA class based on different configurations of the scoring algorithm. Namely, the following three configurations were applied: (i) using only sentence scoring, (ii) using only table segment scoring, and (iii) using both sentence scoring and table segment scoring.

Experiment Evaluation

Recall and precision on class of interest (positive class) are used as the main measures to evaluate prediction performance. The focus is to obtain better recall with respect to restriction to have precision near to 100%. Thresholds were used as a precision—recall tradeoff tool to boost precision up to 100%. The price paid on this is some decrease in recall. At the same time the experiments demonstrate that recall can still be at the level acceptable for practical tasks. The results obtained are presented in Table 2.

TABLE 2
Performance Evaluation

| Scoring Method | Recall | Precision |
|---|---|---|
| Only sentence | 0.15 | 1.00 |
| Only table segment | 0.24 | 1.00 |
| Both sentence and | 0.40 | 1.00 |
| table segment | | |

As can be seen, employing sentence scoring and table segment scoring to work together bring synergetic effects not obtained by prediction performance obtained by sentence scoring and table segment scoring running alone.

Further results from another performance evaluation are included below:

Results for Tables: Baseline result

Focus on Positive class Recall and Positive class Precision
Class of interest (Positive class)
Recall=0.80
Precision=0.85

Focus on Positive class Precision
Class of interest (Positive class)
Recall=0.25
Precision=1.0

Focus on Positive class Recall
Class of interest (Positive class)
Recall=1.0
Precision=77.5

Focus on Positive class Precision
Class of interest (Positive class)
Recall=0.14
Precision=1.0

Focus on Positive class Precision
Class of interest (Positive class)
Recall=0.4
Precision=1.0
Synergetic effect of using Sentences and Tables (wrt Precision=1.0): 49

Recall (sentences)=0.14
Recall (tables)=0.25
Recall (sentences & tables)=0.4

Knowledgebase Interrogation

In a Contact Centre scenario, one is interested in the enhancement provided by linking of text segments to semantic types in the ontology. In order to illustrate the benefit of our methodology, Contact Centre Agents must be able to perform their tasks equally well or with improved efficacy when searching over the Knowledgebase. To assess this we provided Contact Centre Agents with access to the knowledgebase using the industry standard tool for semantic query, namely Top Braid Ensemble, which permits form-based queries using the entities in the ontology model as well as through a graphical query interface. Using TopBraid Ensemble, a study was conducted to test the ability of Tier 1 and 2 agents to find answers to 4 common queries using form-based search, pre-built visual queries. Tier 2 agents were additionally asked to build create visual queries.

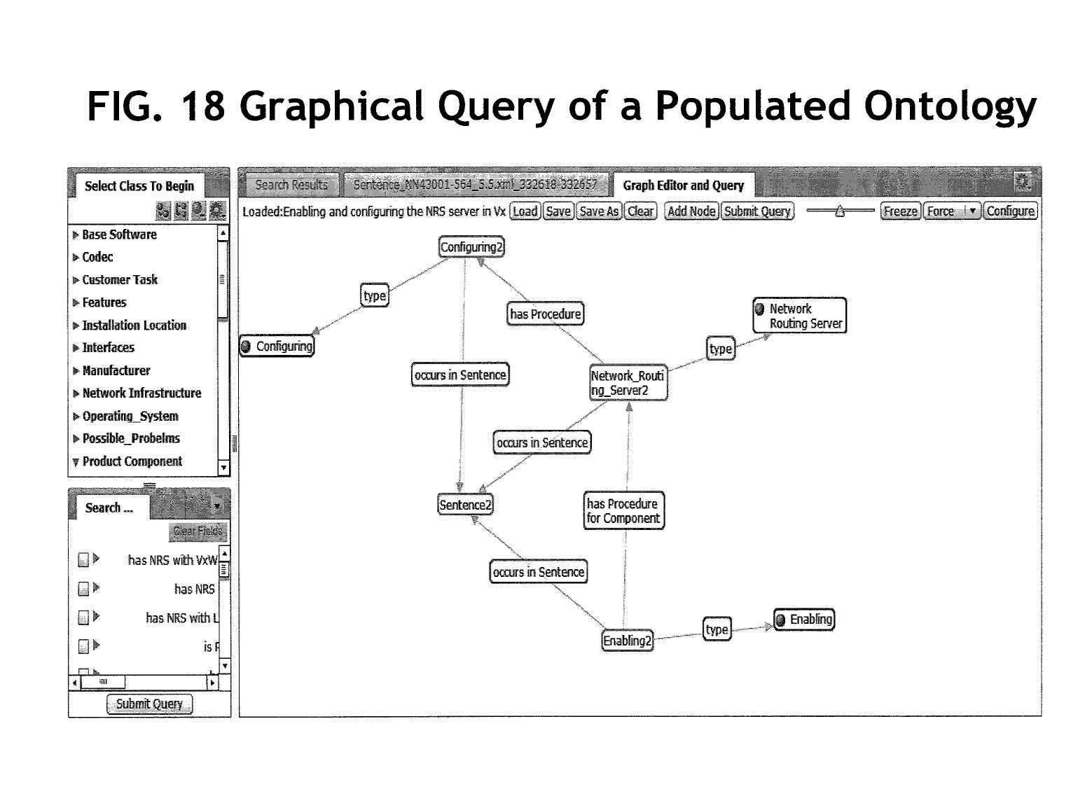

The exact scenario addressed is one where a customer has phone system where the network routing server's end-point keeps de-registering. The assessment was based on the degree to which the Tier 1 agent can complete the troubleshooting. The extended task involves navigation over 12,000+ instances of content (sentences, paragraphs, topics) with different degrees of granularity derived from 18,000 pages of content across 3 software releases and 2000 previous technical support cases. Here we report on the initial usability test on 4 specific queries by Tier 1 and 2 agents. In addition to using Top Braid Live, FIG. 18, the agents were required to perform the same queries using the existing keyword and Boolean search capabilities and of the Adobe Acrobat and relation database forms. The relative increase in productivity, based on time for query answer for Tier 1 agents, using form query in TopBraid Ensemble, resulted on average in a 55% faster query speed whereas the pre-configured general visual query resulted on average in a 61% faster query speed. The pre-configured exact visual query resulted query-answer 3.5 times faster than general visual query. Moreover, Tier 1 agents found the right information with less need for escalation. For Tier 2 agents, who were required to build a visual query themselves, there appeared to be a learning curve with graphical query and the impact was neutral. We attribute this to the changeover from familiar to unfamiliar toolsets. In general the Tier 1 agents found the right information with less need for escalation i.e. they found documents 90% of the time whereas with the older toolset they found correct information only 75% of the time. In contrast, Tier 2 agents, involved in more complex tasks, were less suited to the more complex query building tasks. These results provide evidence to support the contribution made by the ontology population methodology based on scoring OPA candidates prior to ontology population.

It will be understood that methods of the present invention can be used to instantiate ontologies in general. Examples of ontologies that can be instantiated include ontologies in the Telecom and biomedical domains.

The methods described herein may be implemented as computer-readable instructions stored on a computer-readable storage medium that when executed by a computer will perform the methods described herein.

A typical computer system of the present invention includes a central processing unit (CPU), input means, output means and data storage means (such as RAM or a disk drive). A monitor may be provided for display purposes.

Further aspects of the present invention provide: computer-readable code for performing the method of any of the previous aspects; a computer program product carrying such computer-readable code; and a computer system configured to perform the method of any of the previous aspects.

The term “computer program product” includes any computer readable medium or media which can be read and accessed directly by a computer. Typical media include, but are not limited to: magnetic storage media such as floppy disks, hard disc storage medium and magnetic tape; optical storage media such as optical discs or CD-ROM; electrical storage media such as RAM and ROM; and hybrids of these categories such as magnetic/optical storage media.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertain, and those aspects and modifications are within the scope of the invention.

### REFERENCES

1. Alexandre Kouznetsov, Jonas B. Laurila, Christopher J. O. Baker, Bradley Shoebottom: Algorithm for Population of Object Property Assertions Derived from Telecom Contact Centre Product Support Documentation. AINA Workshops 2011: 41-46.

2. Cunningham H., Maynard D., Bontcheva K. and Tablan V. GATE: A Framework and Graphical Development Environment for Robust NLP Tools and Applications. Proceedings of the 40th Annual Meeting of the ACL (2002). 2002.

3. Horridge M., Bechhofer S and Noppens O. Igniting the OWL 1.1 Touch Paper: The OWL API. OWLED 2007, 3rd OWL Experienced and Directions Workshop. 2007.

4. Zhao J., Boley H. and Du W. Knowledge representation and consistency checking in a norm-parameterized fuzzy description logic. Emerging Intelligent Computing Technology and Applications. With Aspects of Artificial Intelligence, LNCS. 5755, 111-123. 2009.

5. Kouznetsov A., Matwin S., Inkpen D, Razavi A. H., Frunza O., Sehatkar M. and Seaward L. Classifying Biomedical Abstracts Using Committees of Classifiers and Collective Ranking Techniques. Advances in Artificial Intelligence, LNCS. 5549, 224-228. 2009.

We claim:

1. A computer-implemented method comprising:
providing a source corpus;
providing a word list;
identifying text in the corpus which is in the word list;
tagging the identified text according to the word list;
identifying a co-occurrence among the tagged text;
determining the number of the co-occurrences in the corpus and the number of words between each of the co-occurrences in the corpus; and
generating a score for the co-occurrence based on the number of the co-occurrences in the corpus and the number of words between each of the co-occurrences in the corpus.

2. The method according to claim 1 wherein the score is usable to rate the relevance of the co-occurrence to an ontology or part thereof.

3. The method according to claim 1 further comprising populating an ontology with the co-occurrence if the score meets a predetermined threshold.

4. The method according to claim 1 wherein the word list comprises synonyms or target terms.

5. The method according to claim 1 wherein the source corpus comprises a text string.

6. The method according to claim 1 wherein the source corpus comprises a table and further comprising extracting text from the table and assembling the text from the table into a text string prior to the identifying step.

7. The method according to claim 1 wherein the co-occurrences are triplets comprising two concept words and a word representing a relationship between the concept words.

8. The method according to claim 1 wherein the generating of a score further comprises a bonus calculation.

9. The method according to claim 7 wherein the triplets comprise an A-box candidate object property.

10. The method according to claim 2 wherein the ontology comprises a T-box.

11. The method according to claim 9 wherein the source corpus comprises a telecom document.

12. The method according to claim 6 wherein the co-occurrences are triplets comprising two concept words and a word representing a relationship between the concept words.

13. The method according to claim 5 further comprising normalizing the score relative to single occurrences of co-occurrence terms in a text string.

14. The method according to claim 1 further comprising converting the score to a binary value using a predetermined threshold.

15. The method according to claim 9 further comprising integrating the A-box candidate object property and a related score in a norm-parameterized fuzzy description logic ontology.

16. A computer-implemented method of populating an ontology comprising:
providing a source text;
annotating the source text;
extracting literature specification units and a named entities from the annotated text;
evaluating possible connections between two or more of the named entities based on co-occurrence of the two or more named entities in the literature specification units;
identifying one or more of the named entities as A-Box individuals based on the evaluating step;
providing an ontology;
instantiating the ontology with the A-Box individuals and object properties between the individuals according to scores above a predetermined threshold.

17. The method according to claim 16 wherein the ontology is a Telecom ontology and the annotating step further comprises using gazetteer lists with Telecom ontology concept synonyms.

18. The method according to claim 17 wherein the evaluating step further comprises using synonyms of named entities in the text segments.

19. A computer-readable storage medium comprising computer readable instructions that when executed by a computer performs the steps according to claim 1.

20. A computer-readable storage medium comprising computer readable instructions that when executed by a computer performs the steps according to claim 16.
